(19) United States
(12) Patent Application Publication
(10) Pub. No.: US 2024/0144276 A1
(43) Pub. Date: May 2, 2024

(54) AGGREGATED MESSAGING IN DYNAMIC BATCHES FOR NETWORK OPTIMIZATION

(71) Applicant: PayPal, Inc., San Jose, CA (US)

(72) Inventors: George Chen Kaidi, Singapore (SG); Deepak Buddha, Singapore (SG); Sreeram Vasudevan, Singapore (SG)

(21) Appl. No.: 17/977,783

(22) Filed: Oct. 31, 2022

(51) Int. Cl. G06Q 20/40; G06Q 20/02; G06Q 20/32

(52) U.S. Cl. CPC G06Q 20/4016; G06Q 20/027; G06Q 20/3255

(57) ABSTRACT

The method, system, and a computer program product are directed to dynamic batching of messages for network optimization, such as Quality of Service (QoS) optimization. The edge server dynamically decides which messages can be processed locally, which messages should be batched and transmitted asynchronously as a batch, and which messages should be processed synchronously. Such message processing improves the QoS of a network.

### FIELD OF INVENTION

Embodiments disclosed herein generally relate to computer networking improvements, and more particularly to using dynamic batch processing of messages for network usage optimization, such as Quality of Service (QoS) optimization.

### BACKGROUND

In the past several decades, rapid advances were made in computer technology and telecommunications. As a result, more interactions are conducted electronically. The electronic interactions include exchanges of messages that are reconciled. This results in more messaging volume between client devices and devices in the messaging network that facilitate the reconciliation. Synchronous communication between client devices and devices in the messaging network that reconcile the messages can have a deleterious effect on the quality of service of a network. For example, the messages may result in an increase in network latency, delays in processing high priority messages, and increased bandwidth utilization in parts of the messaging network. Therefore, Applicant recognizes that there is a need for a networking architecture that increases the Quality of Service (QoS) of the network.

### BRIEF DESCRIPTION OF THE FIGURES

FIG. 1 is a block diagram of a system, according to various aspects of the disclosure.

FIG. 2 illustrates a block diagram of a client device interacting with a Graph QL end point through an edge server, according to various aspects of the disclosure.

FIG. 3 illustrates a block diagram of an edge server, according to various aspects of the disclosure.

FIG. 4 is a block diagram of a system suitable for conducting transactions, according to various aspects of the disclosure.

FIG. 5 is a flowchart illustrating a method for dynamically batching messages, according to various aspects of the disclosure.

FIG. 6 illustrates a block diagram of a system suitable for conducting electronic online transactions on a blockchain, according to various aspects of the disclosure.

FIG. 7 is an example computer system according to various aspects of the disclosure.

FIG. 8 is a simplified example of a cloud-based computing architecture according to various aspects of the disclosure.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

It is to be understood that the following disclosure provides many different embodiments, or examples, for implementing different features of the disclosure. Specific examples of components and arrangements are described below to simplify the disclosure. These are, of course, merely examples and are not intended to be limiting. Various features may be arbitrarily drawn in different scales for simplicity and clarity.

The disclosure pertains to a network architecture having an edge server for dynamic batch processing of messages. The edge server intermediates between client devices in a first network and a remote server in a second network to improve Quality of Service (QoS) of the network. For example, the edge server reduces the network utilization of the second network, based on dynamic batch processing of messages from the first network. The edge server dynamically decides which messages can be reconciled locally, which messages should be batch processed for asynchronous reconciliation with the remote server, and which messages should be synchronously processed with the remote server, thus reducing a number of transmissions in the second network and improving the quality of service (QoS), according to various embodiments. In an example, the edge server may dynamically process the messages based on the number of messages per unit time, the number of client devices sending messages and the relative priorities associated with the messages. For example, some messages may have a higher priority than other messages.

Messaging networks facilitate interactions between client devices in the first network by reconciling messages between the client devices via the messaging system. The first network may include intermediate network devices that facilitate transfer of messages. Example of intermediate network devices may include a router, a third-party client device or a networking device of a service provider such a transceiver at a cellular network tower, base station equipment, a point of sale (POS) device and the like.

In various types of networks, the interactions between client devices and the remote server involves a message sent from the client devices to a remote server and often a response message from the remote server to client devices. In such networks, transmitting these messages in real-time or synchronously results in an increased network utilization at an apex of the network such as near the remote server. For example, the messages handled per minute at the apex of the network may increase, which in turn results in higher bandwidth utilization, an increase in message latency, an increase in response time for the messages and the like. Remote server capability in these networks cannot be offloaded to an intermediate device because different messages need different handling. For example, some messages may need synchronous handling while others can be batch processed. Determining the handling that a message requires is more complicated than the processing the message at the remote server.

In an example, an edge server may dynamically determine whether a message should be locally reconciled, synchronously reconciled with the remote server, or batch processed along with other messages based on parameters associated with the client device. In an example, the edge server may query and cache one or more client device parameters associated with the client device from the remote server. A client device parameter may include information as associated with prior messages of a client device, a trust score associated with the client device, the pre-determined aggregate risk threshold for the client devices, an individual risk threshold from the client device, a pre-determined settlement time limit associated with the client device, or a connectivity status indication associated with the client device.

In some embodiments, the edge server may use a query language such as the Graph QL to query the remote server for client device parameters and to cache them on the edge server. The Graph QL libraries provide a graphical query language for Application Programming Interface(s) (API)s and a runtime for fulfilling those queries from data existing on the remote server. Graph QL libraries may provide data and metadata in response to a query. The metadata may provide linkages such as relational information about the data that is retrieved which allows decisions to be made at the edge server while minimizing the data processing at the edge server. In an example, the edge server may obtain structured data from the remote server. In addition, compared with other API data retrieval methods, Graph QL queries allow the remote server to process the data and send information that is responsive to the query.

For example, assume an interaction between two entities using messages. The edge server may be interested in the number of messages the two entities exchange and the number of these messages that affect the state of a database on the message processing server. In one type of API that can be disadvantageous, the edge server may request the number of messages the two entities exchanged using an endpoint, the number of messages that made changes to the database on the message processing server and then compute the number of messages that affect the state of the database. In the case of a Graph QL query, the edge server may provide information using the query parameters, which allows the remote server to process these instructions and send data and metadata responsive to the query. This reduces the network bandwidth associated with the query.

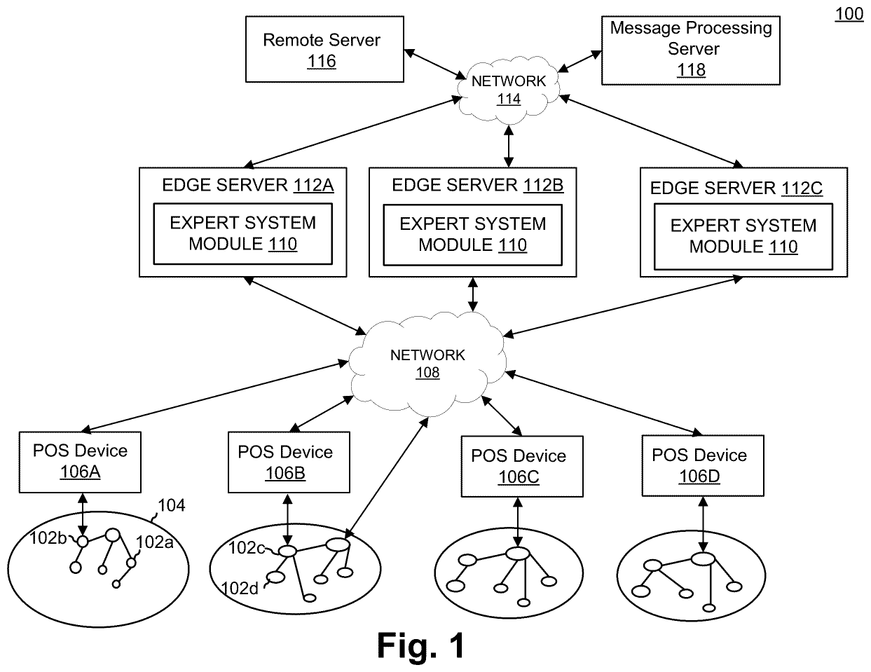

The embodiments are directed to a network architecture having an edge server for dynamic processing of messages that are intermediates between a client device and a remote server. The edge server may dynamically determine whether a message should be synchronously reconciled, locally reconciled or dynamically batch processed along with other messages based on parameters associated with the client device. The various embodiments are discussed in more detail with reference to FIGS. 1-8, below.

FIG. 1 illustrates a block diagram of a system 100 suitable for dynamically processing batches of messages, according to an embodiment. System 100 may comprise or implement a plurality of servers and/or software components that operate to perform reconciliation of messages or processes. Exemplary servers may include stand-alone and enterprise-class servers operating a server OS such as a MICROSOFT™ OS, a UNIX™ OS, a LINUX™ OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include client devices 102 (e.g., client devices 102A, 102B, 102C) connected to various edge servers 112 (e.g., edge servers 112A, 112B) via a network 108. System 100 may also include a remote server 116 and a message processing server 118 connected to edge servers 112 via a network 114. In some embodiments, there may be an intermediate device such as the POS devices 106 (e.g., POS devices 106A-D) between the edge server 112 and the client devices 102. Remote processing server 116, edge servers 112, and POS devices 106 may be managed by a first entity. Message processing server 118 may or may not be managed by the first entity. For example, message processing server 118 may be managed by a second entity unrelated to the first entity, and the second entity may be unaware of the network management performed by the remote server 116, the edge servers 112, the POS devices 106 or a combination thereof.

Network 108 may communicatively connect one or more client devices 102, POS devices 106, or a combination thereof. In an embodiment, the client device 102A, 102B and the like may form a local network that is communicatively connected to edge server 112A. Edge server 112A may connect via the POS device 106A to the client devices 102A, 102B or may connect directly to the client device 102A in the local network that may act as a node of the local network. In an example, the local network may be over low energy blue tooth.

Each edge servers 112A-C may dynamically process messages between the participants in the system on the network 108, network 114 or both. For example, assume the client device 102A and the client device 102B interact with each other through an exchange of messages. In one type of system, the client device 102A may send the messages as part of the interaction to the message processing server 118, which may then send the message to the client device 102B and vice versa. In some instances, the message processing server 118 may reconcile the messages by changing the state of a stored variable in a database associated with the message processing server 118 and notify client device 102A, client device 102B or both with the reconciliation result. For example, client device 102A may be an authorization to transfer information in an account associated with client device 102A to an account associated with client device 102B. During such an interaction, the message processing server 118 handles a lot of overhead messaging and data including acknowledgements of the messages to client device 102A, client device 102B before the messages are reconciled.

In embodiments of the system 100, the edge server 112 may dynamically batch process the messages from the client device 102A, client device 102B or both to reduce the overhead, and minimize the messages that are exchanged between the client devices 102A, 102B and the message processing server 118. In order to dynamically process the messages, edge server 112A may accumulate the messages for asynchronous reconciliation at a later time or reconcile the messages synchronously. Edge server 112A may synchronously reconcile the messages by sending the messages to the message processing server 118, the remote server 116 or both if the risk associated with delaying processing of the message exceeds the increases in efficiency associated with reducing utilization of the message processing server 118. Edge server 112 may also synchronously reconcile the messages by reconciling the messages locally, e.g., at edge server 112, without sending the messages to the message processing server 118.

In an embodiment, edge server 112A may determine the type of processing to apply based on an expert system module 110 that implements a risk-based processing of the messages. Expert system module 110 may execute within edge servers 112. Expert system module 110 may dynamically determine whether to batch process the messages received from the client device 102A, the client device 102B or a combination thereof based on data associated with the client device 102A, the client device 102B or both. In some embodiments, the determination may also depend on the data associated with the POS device 106A. Expert system module 110 may determine whether to batch process the messages based on a device dynamic transaction risk associated with each of the client devices 102 or based an aggregate dynamic transaction risk associated with one or more client devices 102 or a combination of the device dynamic transaction risk and the aggregate dynamic transaction risk.

In order to determine the device dynamic transaction risk or the aggregate dynamic transaction risk, expert system module 110 may query and retrieve data from the remote server 116 such as a message history associated with client device 102A, the client device 102B, or both. The message history may include information such as message reconciliation failures associated with the client device 102A, the client device 102B or both.

Expert system module 110 may determine a device dynamic transaction risk associated with client device 102A based on the message history associated with the client device 102A. For example, the expert system module 110 may determine the device dynamic transaction risk for messages from the client device 102A based on similar messages in the message history being associated with a higher or lower risk that the messages may fail reconciliation. Edge server 112A may determine that similar messages from the past and their reconciliation history may be used to establish similar risks in messages received from the client device 102A. Device dynamic transaction risk is an indication of the risk that one or more messages from the client device 102A will fail to reconcile when sent to the message processing server 118 at a later time.

Expert system module 110 may balance the dynamic device transaction risk with efficiency increases from reducing the frequency of messages that are sent to the message processing server 118 using a pre-determined individual risk threshold. The pre-determined individual risk threshold may indicate a threshold for the individual device dynamic risk below which a failure to reconcile some messages is offset by the efficiency increases associated with the reduction in frequency of messages to the message processing server 118.

Similarly, expert system module 110 may determine an aggregate dynamic transaction risk associated with multiple client devices 102A, 102B based on the message history associated with client devices 102A and 102B. Aggregate dynamic transaction risk is an indication of the risk that one or more messages from client device 102A, client device 102B or combination thereof may fail to reconcile when sent to the message processing server 118 at a later time. Expert system module 110 may balance the dynamic device transaction risk with efficiency increases from reducing the frequency of messages that are sent to the message processing server 118 using a pre-determined dynamic risk threshold. The pre-determined dynamic risk threshold may indicate a threshold for the aggregate dynamic transaction risk below which a failure to reconcile some messages is offset by the efficiency increases associated with the reduction in frequency of messages to the message processing server 118.

The expert system module 110 may synchronize the messages with remote server 115 or message processing server 118 when the risk associated with accumulating the messages exceeds the aggregate transaction risk threshold, the pre-determined individual risk threshold or a combination thereof. For example, expert system module 110 may synchronize accumulated messages when the aggregate dynamic transaction risk exceeds the pre-determined aggregate risk threshold, when the device dynamic transaction risk for client device 102A exceeds the pre-determined individual risk for that client device 102A, or a combination of thereof. Thus, expert system module 110 may dynamically process the messages to minimize the risk using these thresholds to mitigate the individual risk associated with client device 102A or aggregate risk associated with the client devices 102A, 102B and the like.

Assume the client device 102A is associated with messages that failed to reconcile in the past. In an example, messages may fail to reconcile because the client device 102A sends other messages through other communication channels to the message processing server 118 which changes the state of the variable in the database associated with the message processing server 118. For example, the client device 102A may through other communication channels transfer information to an account associated with e.g., client device 102C. This transfer to device 102C may be later than the transfer in the messages that are batch processed at edge server 112A transferring a file from the account associated with client device 102A to an account associated with the client device 102B. Thus, the delay induced by batch processing may result in failed message reconciliation. In an example, expert system module 110 may determine based on the history of prior failures that the device dynamic transaction risk associated with messages from the client device 102A is higher than that of a device without a history of such failed reconciliation.

Assume, in an example, that client devices 102A and 102B are associated with a message history that indicates that the prior messages reconciled successfully. In this example, the expert system module 110 may determine an aggregate dynamic transaction risk associated with delaying the processing of messages from the client device 102A, 102B and the like is lower than a group of devices with prior messages that have failed reconciliation.

Expert system module 110 may alone or in conjunction with remote server 116 determine a pre-determined aggregate transaction risk threshold associated with the client device 102A, the client device 102B or both. For example, edge server 112 may determine the aggregate transaction risk threshold based on a number of messages edge server 112 may accumulate for batch processing at a later time before the risk that these messages may fail reconciliation at the message processing server 118 no longer offsets the efficiency in reduction of interactions with the message processing server 118. In an example, edge server 112 may determine the aggregate risk threshold based on balancing the gains from the reduction in avoiding interaction with the message processing server 118, and the risk associated with the failure of the reconciliation of messages when the processing of the messages is delayed by accumulation of the messages.

The aggregate transaction risk threshold may apply to the client device 102A, the client device 102B or both. For example, the client device 102A may send multiple messages during an interaction with the client device 102B that may be accumulated at edge server 112A for batch processing and/or later reconciliation. The expert system module 110 may accumulate messages from the client device 102A which may be engaged in multiple interactions and may result in the pre-determined aggregate risk threshold being exceeded based on the messages from the client device 102A.

In another example, the aggregate transaction risk threshold may apply to a combination of the messages from the client device 102A, and the client device 102B. For example, the expert system module 110 may need to balance the overall risk that accumulating messages from the client device 102A and the client device 102B may result in the messages from the client device 102A, the client device 102B or both failing to reconcile.

The expert system module 110 may determine the pre-determined aggregate risk threshold or the pre-determined individual risk threshold. The determination may be based on the number of messages per unit time (e.g., 5 minutes, 10 minutes, and hour), the number of client devices 102 sending messages, the relative weights associated with the messages, the connectivity states of the client devices and the like.

In an embodiment, the expert system module 110 may determine the pre-determined aggregate risk threshold as a function of the number of messages that may be accumulated for batch processing at edge server 112. In some embodiments, the expert system module 110 may dynamically determine the number of messages that may be accumulated for batch processing based on the message reconciliation history associated with the client devices 102, such as client device 102A, client device 102B or both.

In an embodiment, expert system module 110 may determine the pre-determined aggregate risk threshold based on time elapsed between reconciliations. For example, expert system module 110 may determine the pre-determined aggregate risk threshold based on the risk versus efficiency gain metric. The risk may be associated with messages failing to reconcile due to the delay commensurate with batch processing of messages offsetting the efficiency gain from reduction in frequency of transmitting messages to message processing server 118. For example, the expert system module 110 may determine the pre-determined aggregate risk threshold based on time of day. Increasing the time between transactions at a certain time of the day, week, month or year may be associated with higher message reconciliation failures. For example, expert system module 110 may determine the pre-determined aggregate risk threshold is higher during the lean hours for interactions between the client devices such as between 11.00 A.M. and 1.00 P.M., for a specific location. The expert system module 110 may decrease the frequency of reconciliation of batch messages based on this increased pre-determined aggregate risk threshold. In an embodiment, expert system module 110 may similarly determine the pre-determined individual risk threshold based on time elapsed between reconciliations.

Expert system module 110 may determine the pre-determined aggregate risk threshold based on the number of client devices in the network 108. In an example, the expert system module 110 may determine the pre-determined aggregate risk threshold is higher when the number of client devices 102 is lower because the number or volume of messages generated may be lower when the number of client devices 102 is lower.

In an embodiment, expert system module 110 may determine the pre-determined aggregate risk threshold based on a numerical value associated with the message. For example, the expert system module 110 may synchronously process high numerical value messages to reduce the risk that the messages will not reconcile. A high numerical value message may be one where the efficiency gains from delaying reconciliation at the message processing server 118 is not comparable to the risk associated with just one failed reconciliation of the high numerical value message. The expert system module 110 may synchronously process high value messages. In an embodiment, expert system module 110 may similarly determine the pre-determined individual risk threshold based on a numerical value associated with the message.

In an embodiment, expert system module 110 may determine the pre-determined aggregate risk threshold based on connectivity status of the client device 102A. In an example, the expert system module 110 may determine the pre-determined aggregate risk threshold should be lowered when client device 102A is no longer connected to the network 108. Similarly, expert system module 110 may determine the pre-determined individual risk threshold based on connectivity status of the client device 102A.

Edge server 112A may process the messages synchronously or asynchronously when the messages change the state of a database external to the network 108 such as on message processing server 118, remote server 116, or both. In an embodiment, edge server 112A may process the messages that change the state of the external database asynchronously based on a risk score associated with the client device 102A, the message or both. For example, the state of a variable in a database may relate to a stored value associated with the client device 102A being changed by a third party. The message processing server 118 may flip a flag associated with the entity indicating the entity has failed to reconcile messages.

In some examples, the edge server 112A and the remote server 116 may be operated by the same entity, and that the message processing server 118 may be operated by a third-party. In instances where the message from the client device 102A affects the state of the external database stored on the remote server 116, the messages may be processed dynamically in a batch with other messages and then reconciled asynchronously to update the changes to the state of the variables stored on the remote server 116. In the same example, in instances where the message from the client device 102A affects the state of a database stored on the third-party message processing server 118, the messages may be asynchronously processed or dynamically batch processed with other messages from the network 108. In some embodiments, the edge server 112A may asynchronously process the messages from the client device 102A that changes the state of the database in the message processing server 118 based on a risk score associated with the client device 102A. The edge server 112 may determine that when a device dynamic transaction risk associated with the client device 102A exceeds a pre-determined threshold, and the message may be synchronously processed.

The edge server 112A may use an expert system module 110 to determine the device dynamic transaction risk based on non-limiting criteria. Example criteria may be prior messages of client device 102A, a trust score associated with client device 102A, the pre-determined aggregate risk threshold for the client devices 102A and 102B which may be within a sub-group of the network 108 (local network 104), an individual risk threshold associated with client device 102A, a pre-determined settlement time limit associated with client device 102A, or a connectivity status indication associated with client device 102A.

The client device 102A interaction with the POS device 106A may be a regular interaction. Regular interactions are interactions where client device 102A has previously communicated messages to POS device 106A. Regular interactions are predictable based on the history of the interactions that included similar messages. The edge server 112A may query the remote server 116 to retrieve the parameters associated with the client device 102A. In an embodiment, the edge server 112A may query the remote server 116 using a Graph QL query or a POST query. The response from the remote server 116 may be cached on the edge server 112A to reduce bandwidth utilization for future messages. The edge server 112A, the remote server 116 or both may store this history of interactions and use this information to determine the pre-determined individual transaction risk threshold of the client device 102A. In some embodiments, the edge server 112A may similarly determine the predefined aggregate risk threshold based on a history of interactions, such as messages between the POS device 106A, the client device 102A, the client device 102B or a combination thereof.

The edge server 112A may determine the pre-defined aggregate risk threshold based on historical patterns in the messages from the network 108, the POS device 106A, the client device 102A, the client device 102B or a combination thereof. In an example, the pre-defined aggregate risk threshold may vary based on the devices in the local network 104. The edge server 112A may determine an aggregate dynamic transaction risk for the messages from the client device 102A and the client device 102B connected to network 108. Edge server 112A may determine the risk associated with a message from the client device 102A based on the risk associated with the client device 102A. Similarly, edge server 112A may determine the risk associated with a message from the client device 102B based on the risk associated with the client device 102B. The edge server 112A may determine the aggregate dynamic transaction risk based on the risk associated with the message from the client device 102A and the risk associated with the client device 102B. The edge server 112A may determine whether the aggregate dynamic transaction risk exceeds the pre-defined aggregate risk threshold. The edge server 112A may dynamically collect the messages from the network 108 such as from the client device 102A and the client device 102B when the aggregate dynamic transaction risk does not exceed the pre-defined aggregate risk threshold. The edge server 112A may transmit the messages from the network 108 as a batch of messages to the network 114 based on the aggregate dynamic transaction risk exceeding the pre-defined aggregate risk threshold. The remote server 116, the message processing server 118 or both may reconcile the batch of messages.

The edge server 112A may set a device dynamic transaction risk for messages from the client device 102A and a pre-determined individual risk threshold based on the risk associated with the client device 102A. The device dynamic transaction risk may be a counter that counts the number of messages that may be batched together for asynchronous processing. The pre-determined individual risk threshold may be a threshold number of messages that edge server 112A may batch together for asynchronous processing. For example, assume client device 102A is a new device and the edge server 112A or the remote server 116 does not have parameters associated with client device 102A. The risk associated with the client device 102A may be high because client device 102A is new and the device parameters associated with the client device 102A may not be known to edge server 112A, remote server 116, or message processing server 118. Accordingly, edge server 112A may set the pre-determined individual risk threshold to a low threshold, e.g., two or three messages. Once client device 102A begins to perform transactions using edge server 112A, remote server 116 or message processing server 118, the pre-determined individual risk threshold may be increased to a higher pre-determined individual risk threshold, e.g., ten messages. The edge server 112A may aggregate the messages from the client device 102A for asynchronous processing as long as the device dynamic transaction risk does not exceed the pre-determined individual risk threshold. With each message that is aggregated, the device dynamic transaction risk may increase by one. Once the edge server 112A determines that the device dynamic transaction risk exceeds the pre-determined individual risk threshold, the edge server 112A may transmit the aggregated batch messages as a batch to the remote server 116, the message processing server 118 or both for reconciliation.

The edge server 112A may also send the messages to the remote server 116, the message processing server 118 or both when a pre-determined settlement time limit associated with client device 102 is exceeded. Messages may be reconciled every pre-determine settlement time period. The pre-determined settlement period may be set using the pre-determined settlement time limit. For example, edge server 112 may aggregate messages from client device 102 as long as the time the messages are stored in edge server 112A is less than the pre-determined settlement time limit. Once the pre-determined settlement time limit is met, edge server 112A transmits the messages to remote server 116 or message processing server 118.

In some instances, the edge server 112A may also send the messages to the remote server 116, the message processing server 118 or both based on a connectivity status. For example, when edge server 112A detects that client device 102A is no longer accessible on the network 108, edge server 112A may transmit the message or batched messages to remote server 116 and/or message processing server 118 regardless of values associated with the pre-determined settlement time limit and pre-determined individual risk threshold.

As discussed above, there may be multiple edge servers 112, such as edge servers 112A-C that may interact with client devices 102 that may be connected to sub-networks of the network 108. For example, the edge server 112A may mediate messages between client devices 102A and 102B that are connected to POS device 106A via sub network 135, messages between the client devices 102C and 102D connected to the POS device 106B, and the like. In an embodiment the multiple edge servers 112A-C may interact with each other through the network 108, the network 114 or both. The remote server 116 may facilitate the exchange between the multiple edge servers 112A-C.

In some embodiments, client device 102A may interact with client device 102C through messages that are mediated by the edge server 112A and the edge server 112B. The edge server 112A and the edge server 112B may reconcile messages locally, synchronously, or asynchronously with the remote server 116, and/or the message processing server 118. The edge server 112A, the edge server 112B or both may determine how to process the messages as described above based on the expert system module 110. In an example, the edge servers 112A and 112B may process messages that are reconcilable with each other without affecting the state of a database on the remote server 116, the message processing server 118 or both. Similarly, the edge servers 112A and 112B may process the messages synchronously or asynchronously when the messages change the state of a database external to the network 108 such as a database associated with message processing server 118, remote server 116 or both. Edge servers 112A and 112B may process the messages that change the state of the external database asynchronously based on risk score associated with the client device 102A, the message or both.

Processing and batching messages at edge server 112A may reduce the network utilization. This is because batch processing messages in batches may result in some of the messages cancelling each other out. Processing messages at edge server 112A may also eliminate obsolete and irrelevant messages from being transmitted over network 114. For example, the client device 102A and the client device 102B may exchange messages to interact with each other over networks 108 and 114. The client device 102A may recall the message to client device 102B because of a change in circumstances, e.g., client device 102A cancelling a transaction. The edge server 112A when batch processing the messages may remove the cancelled message from the batch, such that the cancelled message is not transmitted to remote server 116 and/or message processing server 118. This may reduce the volume of messages sent over network 114.

Batch processing of messages may also reduce the bandwidth utilization. This is because edge server 112A may transmit the messages in a single batch, rather than multiple single messages. Edge server 112A may increase the quality of service of the network 114 by reducing volume and frequency of messages.

Client devices 102A-D may be implemented using any appropriate hardware and software configured for wired and/or wireless communication over network 108. Client devices 102A-D may be implemented as a personal computer (PC), a smart phone, a smart phone with additional hardware such as NFC chips, BLE hardware and the like, a wearable device with similar hardware configurations such as a gaming device, a Virtual Reality Headset, or a device that talks to the smart phone with unique hardware configurations and running appropriate software. Client devices 102A-D may also be implemented as a laptop computer, and/or another type of a computing device capable of transmitting and/or receiving data, such as an iPad™ from Apple™.

Client devices 102A-D, remote server 116, message processing server 118, may each include one or more electronic processors, electronic memories, and other appropriate electronic components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 108, network 114 or both. Networks 108 and 114 may be implemented as a single network or a combination of multiple networks. For example, in various embodiments, networks 108 and 114 may include the Internet or one or more intranets, landline networks, wireless networks, and/or other appropriate types of networks.

As illustrated in FIG. 1, the expert system module 110 may be implemented on edge server 112, although expert system module 110 may also be implemented on the remote server 116. Expert system module 110 may include one or more software applications or software programs that may automatically execute (e.g., without needing explicit instructions from a human user) to perform certain tasks. For example, the expert system module 110 may electronically access one or more electronic databases (e.g., the database of the remote server 116 or the database of the message processing server 118, or both) to access or retrieve parameters associated with client devices 102A-D or with an entity, such as a user. The plurality of parameters may contain event data, which may pertain to various historical events involving the entity. For example, the event data for each event may indicate event features, such as the price and/or amount of a transaction conducted by the entity, whether the transaction is a peer-to-peer transaction, the payment flow of the transaction, whether the transaction was authorized, and the like. The expert systems module 110 may include machine learning instructions to determine when to locally mediate the messages, when to synchronously process the messages and when to asynchronously process the messages by dynamically batching the messages.

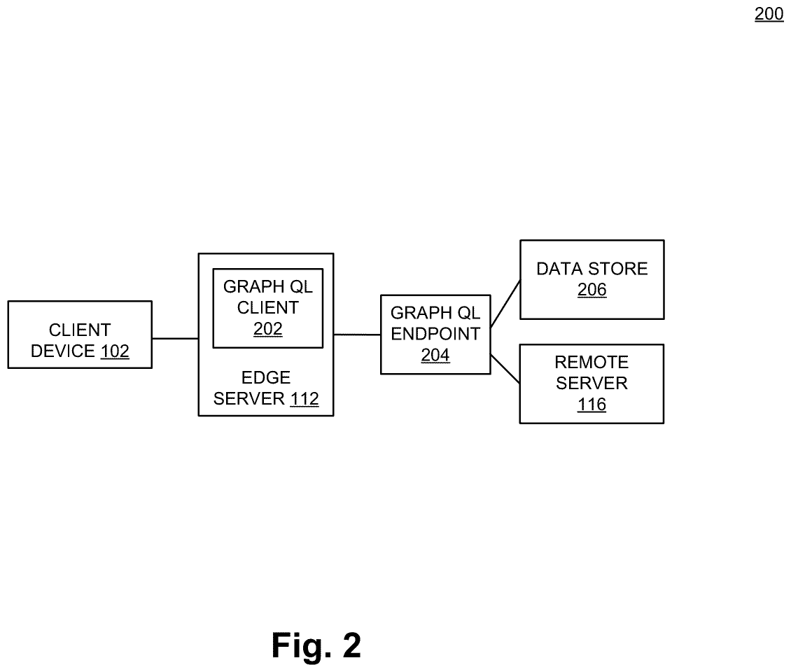

FIG. 2 is a block diagram 200 illustrating an edge server interacting with a Graph QL end point, according to various aspects of the disclosure. Edge server 112 may interact with a Graph QL endpoint 204 to obtain device parameters such as message history, message reconciliation history, account parameters associated with the client device 102. Graph QL endpoint 204 is a service that responds to a query from a Graph QL client 202 with data responsive to the query. In an example, to communicate with the Graph QL endpoint 204, edge server 112 may include a Graph QL client 202. Graph QL client 202 is a runtime for fulfilling those queries from data existing on the remote server 116. Edge server 112 may use the Graph QL query to reduce the processing on edge server 112 by obtaining information that is directly responsive to the query instead of receiving message history and parsing the message history, which increases the bandwidth utilization and increases the processing at edge server 112.

For example, when the client device 102 connects to a local network such as network 108 (shown in FIG. 1), edge server 112 may process a message sent to the remote server 116 to authenticate client device 102. In some embodiments, POS device 106 may trigger an authentication of client device 102 when the client device 102 interacts with the POS device 106. Edge server 112 may use the Graph QL client 202 to compose a Graph query that requests information about the client device 102. For example, the data requested may include information about the message history, the message reconciliation failure rate associated with the client device 102 and the like. Edge server 112 may store this information locally on edge server 112 to mediate messages from the client device 102.

Assume the client device 102 returns to the local network 104 the next day. The POS device 106 (shown in FIG. 1) may once again trigger an authentication. Edge server 112 may compose a new Graph QL query that requests updates since the previous day. The Graph QL endpoint 204 may provide the data responsive to the query to edge server 112. Unlike the prior systems, edge server 112 may mediate the messages from the client device 102 based on the updated data without retrieving and/or processing the entire data from the remote server 116.

In an example, the message history may include client device parameters and entity account parameters. The client device parameters and entity account parameters may include activities or events associated with the client device 102 or the entity associated with the client device 102. For example, entity activities may include activities related to an account of the entity, such as a login or a logout attempt, an addition or a removal of a financial instrument (FI) (e.g., checking account, savings account, credit card number, and the like), an edit of a merchant profile, an authentication flow, a contact with other entities, such as with a customer service representative of the electronic transaction platform, or providing of certain documents. The entity activities may also include activities related to one or more transactions in the form of messages, such as an attempt to send or sending funds, attempt to receive or receiving funds, attempt to exit out of the transaction, and the like. These examples are non-limiting as other activities and events may be analyzed and included a part of the entity account parameters.

The client device parameters may include details of interactions with the message processing server 118 (shown in FIG. 1.) As non-limiting examples, the interactions may include using an agent to open an account for the entity, setting an account level flag (e.g., trustworthy user or fraudulent user) for the entity, performing risk actions (e.g., risk analysis actions or risk mitigation actions on entity), or reviewing cases associated with the entity, and the like. In other words, the activities of the entity may be retrieved and analyzed to generate account parameters, which may then be used by the expert system module 110 discussed in FIG. 1 to determine the risk associated messages from client device 102.

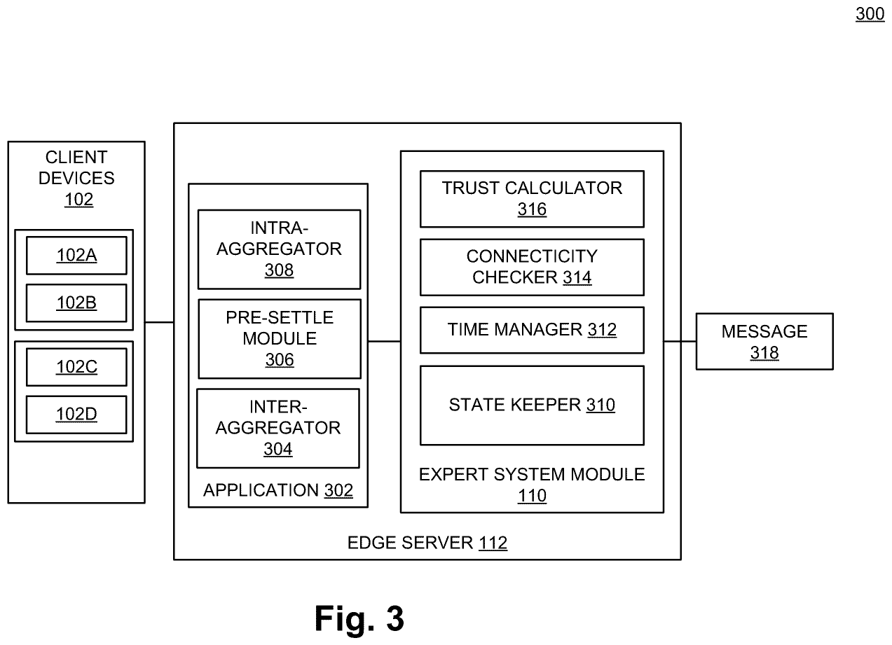

FIG. 3 is a block diagram 300 of an edge server, according to various aspects of the disclosure. The edge server 112 may include an application 302 that processes messages and the expert system module 110 to determine how to process the messages. The application 302 may be software configured to execute on edge server 112 and may further include instructions in modules that are an inter-aggregator 304, a pre-settle module 306, an intra-aggregator 308, and. Application 302 may process messages received at the edge server 112 from client devices 102 based on the processing criteria set by the expert system module 110.

As illustrated in FIG. 1, client devices 102, such as client devices 102A-D may be connected to different POS devices, such as POS devices 106A and 106B. The inter-aggregator 304 may aggregate messages from client devices 102A, 102B, 102C, and 102D that are connected to different POS devices 106. The inter-aggregator 304 communicates with other edge servers 112 such as edge server 112A, 112B, 112C (shown in FIG. 1) to aggregate messages that may be communications between client devices 102 connected using the network 108 The inter-aggregator 304 may aggregate messages that are part of an interaction between the two client devices 102 on one of the edge servers 112 to reduce the use of the message processing server 118 (shown in FIG. 1.)

As also illustrated in FIG. 1, client devices 102, such as client devices 102A and 102B, may be connected to the same POS device, such as POS device 106A (shown in FIG. 1). The intra-aggregator 308 may aggregate messages between the client devices 102 that are connected to POS device 106A. The intra-aggregator 308 may receive the messages form client devices 102A and 102B and accumulate the messages until the expert system module 110 determines that the individual risk or the aggregate risk associated with accumulating the messages is less than the respective pre-determined thresholds as described above with respect to FIG. 1.

Application 302 may receive a plurality of messages from a network 108 (shown in FIG. 1) and pass the messages to expert system module 110. The expert system module 110 may determine whether to locally reconcile the messages using pre-settle module 306, synchronously process the message with the message processing server 118, or asynchronously process the message using dynamic batch processing. The pre-settle module 306 may receive messages from client devices 102A-B that are located under the same edge server 112, e.g., edge server 112A (as shown in FIG. 1) or collect messages from client devices 102A-D that are located under different edge servers 112A, 112B (as shown in FIG. 1) and reconcile the messages. For example, pre-settle module 306 may reconcile messages that cancel each other out or messages that transfer some parameter from a first account to a second account.

As discussed above, edge server 112 may include the expert system module 110. The expert system module 110 may include a state keeper 310, a time manager 312, a connectivity checker 314, and a trust calculator 316. The trust calculator 316 may determine a trust score associated with client device 102. The trust calculator 316 may rely on client device parameters associated with the client device 102 that are retrieved from the remote server 116 (not shown) to determine the trust score. For example, trust calculator 316 may determine that the client device 102 has a low trust score because messages from client device 102 were rejected by the message processing server 118 in the recent interactions with the client device 102. Similarly, the trust calculator 316 may determine that the client device 102 has a high trust score based on events that indicate messages that were successfully reconciled at the message processing server 118. Example low and high trust scores may be flags, or scores within a predefined range, such as between zero and ten where scores that are from zero to two are low trust scores and scores that are from eight to ten are high trust scores.

In some embodiments, the trust calculator 316 may determine a high trust score because client device 102 has transacted from the same geographic location. The same geographic location may be determined through the POS device 106 discussed in FIG. 1. The trust score may be dynamically calculated based on the results of a query to remote server 116 and datastore 206 (as shown in FIG. 2.) The expert system module 110 may use the trust score to determine whether to locally reconcile messages from one or more client devices 102, to asynchronously reconcile messages from the one or more client devices 102 using dynamic batch processing with the message processing server 118 or to synchronously reconcile messages from each client device 102 with the message processing server 118. In an example, expert system module 110 may use the trust score that trust calculator 316 generated for the client device 102 to determine a device dynamic transaction risk associated with the message from the client device 102. The edger server 112 may also retrieve a pre-determined individual risk threshold from the remote server 116.

Assume in an example, edge server 112 receives messages from client device 102A and 102B. The trust calculator 316 may determine the aggregate dynamic transaction risk based on the trust score associated with the client device 102A, client device 102B, or both. For example, assume the client device 102A has a low trust score. The expert system module 110 may reconcile the messages synchronously for both the client device 102A and 102B irrespective of the trust score of client device 102B whenever a message from client device 102A arrives because of the low trust score of client device 102A.

Assume in an example, the client device 102A has a high trust score and the client device 102B has a low trust score. The expert system module 110 may decide to asynchronously reconcile messages from the client device 102A and synchronously process messages from the client device 102B using dynamic batch message processing. The expert system module 110 may also determine aggregate dynamic transaction risk threshold for the client device 102A, client device 102B, or a combination thereof, based on the trust score for the individual devices.

Assume in an example, the client device 102A has a trust score, the expert system module 110 may modify this trust score based on updated message reconciliation history. For example, the client device 102A may have improved the successful reconciliations of messages in the past ten messages or the reconciliations may have failed after the trust score was assigned to client device 102A. Expert system module 110 may determine a new trust score associated with the client device 102A, which may be higher or lower than the initial trust score based on the updated message reconciliation history. The expert system module 110 may change the aggregate dynamic transaction risk threshold based on the new trust score.

As discussed above, expert system module 110 may include the connectivity checker 314. The connectivity checker 314 may determine the connectivity status of the client device 102A. As discussed in FIG. 1, client device 102A may be connected to the network 108 and local network 104. The connectivity checker 314 may periodically check whether the client device 102A is still connected to network 108 and/or local network 104 and generate a connectivity status.

Expert system module 110 may use the connectivity status of client device 102A to determine whether to reconcile messages from client device 102A locally on edge server 112, or synchronously or asynchronously over network 114. For example, the expert system module 110 may send the message from the client device 102A to the remote server 116 or the message processing server 118 as soon as the connectivity status indicates the client device 102A is no longer connected to the local network 104, the network 108 or both, irrespective of other individual or aggregate risks.

In an embodiment, expert system module 110 may use the time between message reconciliations to determine whether to reconcile messages from client device 102A locally, synchronously or asynchronously. Time manager 312 may track the time between message reconciliations for the client devices 102A-D. The time manager 312 may track the number of messages from each one of client device 102A-D and the number of client devices such as the client device 102A-D, and the total number of messages from all client devices 102A-D. Suppose the time between reconciliations for client device 102A is set to ten minutes, the time for reconciliations for client device 102B is set to 15 minutes, and the time for client device 102C-D is set to twenty minutes. In this case, expert system module 110 would transmit the batch that includes messages from client device 102A after the ten minutes expire, even if the batch includes messages from client devices 102B-D. Alternatively, expert system module 110 may transmit messages from client device 102A only after the ten minutes expire, while continue to accumulate messages from client devices 102C-D in the batch. In another example, if the batch includes messages only from client devices 102C-D, the expert system module 110 would send the batch that includes messages from client devices 102C-D after thirty minutes.

In an embodiment, the state keeper 310 may track a state of a client device 102A. For example, the state of the payment or the messages from the client device 102A that are to be processed may be tracked by the state keeper 310. The edge server 112 may use the state of the client device 102A to decide which messages should be synchronously reconciled with the message processing server 118 on the network 114 and the like. The edge server 112 may reconcile the messages using intra-aggregator 308, an inter-aggregator 304 and a pre-settle module 306 module with the network 108.

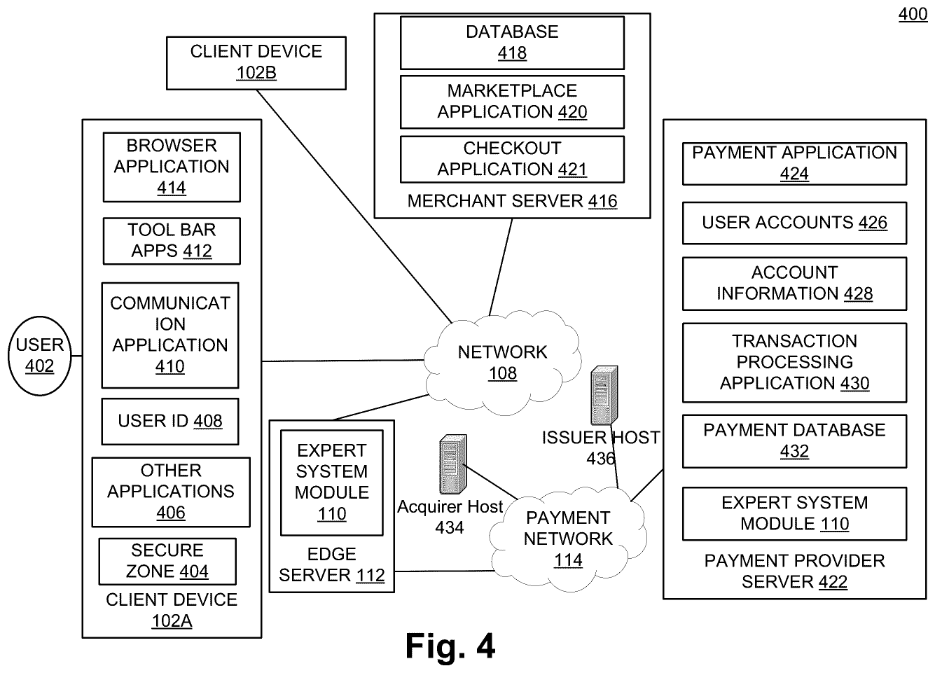

FIG. 4 is a block diagram of a system 400 according to aspects of the disclosure. System 400 may be suitable for conducting electronic online transactions. System 400 may include client devices 102 (e.g., 102A and 102B) and an edge server 112, network 108, and network 114 discussed in FIG. 1. Additionally, system 400 may include a merchant server 416, a payment provider server 422, an acquirer host 434, an issuer host 436, and a payment network 114. These components may be implemented using some or all components discussed with respect to servers 116 and 118 of FIG. 1. Client devices 102A, 102B, edge server 112 and merchant server 416 may communicate with each other using network 108. Edge server 112 and payment provider server 422 may communicate with each other using network 114, which may be a payment network. Acquirer host 434 and issuer host 436 may also communicate with payment provider server 422 using network 114.

Client devices 102A, 102B may include one or more browser applications 414. Browser applications 414 may be used to provide a convenient interface to permit a user 402 to browse information available over network 108. Browser application 414 may be implemented as a web browser configured to view information available over the Internet, such as a user account for online shopping and/or merchant sites for viewing and purchasing goods and services. Client devices 102A, 102B may also include one or more toolbar applications 412 which may be used, for example, to provide client-side processing for performing desired tasks in response to operations selected by user 402. In one embodiment, toolbar application 412 may display a user interface in connection with browser application 414.

Client devices 102A, 102B may include other applications to perform functions, such as email, texting, voice and IM applications that allow user 105 to send and receive emails, calls, and texts through network 108, as well as applications that enable the user to communicate, transfer information, make payments, and otherwise utilize a digital wallet through the payment provider as discussed herein.

Client devices 102A, 102B may include one or more user identifiers 408. User identifiers 408 may be implemented as operating system registry entries, cookies associated with browser application 414, identifiers associated with hardware of client devices 102A, 120B, or other appropriate identifiers, such as used for payment/user/device authentication. In one embodiment, user identifier 408 may be used by a payment service provider to associate user 402 with a particular account maintained by the payment provider.

A communications application 410, with associated interfaces, enables client devices 102A, 102B to communicate within system 400.

Client devices 102A, 102B may also include other applications 406, for example the mobile applications that are downloadable from the Appstore™ of APPLE™ or GooglePlay™ of GOOGLE™.

In conjunction with user identifiers 408, client device 102 may also include a secure zone 404 owned or provisioned by the payment service provider with agreement from device manufacturer. The secure zone 404 may also be part of a telecommunications provider SIM that is used to store appropriate software by the payment service provider capable of generating secure industry standard payment credentials or other data that may warrant a more secure or separate storage, including various data as described herein.

Edge server 112 may be maintained, for example, by a service provider such as PayPal. Edge server 112 may intermediate between the network 108 connecting devices such as the client devices 102A, 102B, the merchant server 416 and the like and network 114 that interfaces with the payment provider server 422. Edge server 112 may include an expert system module 110 to intelligently facilitate processing of transactions from the client devices 102A and 102B as discussed in FIG. 1.

Edge server 112 may determine the type of processing to apply based on an expert system module 110 that implements a risk-based message processing. As discussed in FIG. 1, edge server 112 may include expert system module 110. Expert system module 110 may dynamically determine whether to batch process the messages received from the client device 102A, the client device 102B or a combination thereof. Expert system module 110 may determine whether to batch process the messages based on a device dynamic transaction risk associated with each of the client devices 102A-B or based an aggregate dynamic transaction risk associated with one or more client devices 102A-B or a combination of the device dynamic transaction risk and the aggregate dynamic transaction risk.

Merchant server 416 may be maintained, for example, by a merchant or seller offering various products and/or services. The merchant may have a physical point-of-sale (POS) store front. The merchant may be a participating merchant who has a merchant account with the payment service provider. Merchant server 416 may be used for POS or online purchases and transactions. Generally, merchant server 416 may be maintained by anyone or any entity that receives money, which includes charities as well as retailers and restaurants. For example, a purchase transaction may be payment or gift to an individual. Merchant server 416 may include a database 418 identifying available products and/or services (e.g., collectively referred to as items) which may be made available for viewing and purchase by user 402. Accordingly, merchant server 416 also may include a marketplace application 420 which may be configured to serve information over network 108 to browser application 414 of client devices 102A, 102B. In one embodiment, user 402 may interact with marketplace application 420 through browser applications over network 108 in order to view various products, food items, or services identified in database 418.

According to various aspects of the disclosure, the merchant server 416 may also host a website for an online marketplace, where sellers and buyers may engage in purchasing transactions with each other. The descriptions of the items or products offered for sale by the sellers may be stored in the database 418. For example, the descriptions of the items may be generated (e.g., by the sellers) in the form of text strings. These text strings are then stored by the merchant server 416 in the database 418.

Merchant server 416 also may include a checkout application 421 which may be configured to facilitate the purchase by user 402 of goods or services online or at a physical POS or store front. Checkout application 421 may be configured to accept payment information from or on behalf of user 402 through payment provider server 422 over network 108. For example, checkout application 421 may receive and process a payment confirmation from payment provider server 422, as well as transmit transaction information to the payment provider and receive information from the payment provider (e.g., a transaction ID). Checkout application 421 may be configured to receive payment via a plurality of payment methods including cash, credit cards, debit cards, checks, money orders, or the like

Payment provider server 422 may be maintained by a payment service provider, such as PayPal™, Inc. of San Jose, CA. User 402 may utilize client devices 102A-B to perform an electronic transaction using payment provider server 422. For example, user 402 may utilize client device 102A to visit a merchant's web site provided by merchant server 416 or the merchant's brick-and-mortar store to browse for products offered by the merchant. Further, user 402 may utilize client device 102A to initiate a payment transaction, receive a transaction approval request, or reply to the request. Note that transaction, as used herein, refers to any suitable action performed using the client device, including payments, transfer of information, display of information, and the like. Although only one merchant server 416 is shown, a plurality of merchant servers may be utilized if the user is purchasing products from multiple merchants.

In some embodiments, the client device 102A and 102B may form a local network through a POS device (such as a POS device 106A of FIG. 1) on the premises of a merchant's brick and mortar store. For example, the client device 102A and 102B may be at a Starbucks branch in San Jose, CA. The POS device may be in communication with the client device 102A and 102B through a local network associated with the Starbucks branch. The client device 102A and 102B may be in communication with the payment provider server 422 through the POS device that interfaces with the local network (not shown).

Transactions initiated by client devices 102A-B at the store location may be processed at the edge server 112 before they are dynamically batched and sent to the payment provider server 422. As discussed in FIG. 1, batch processing may reduce a number of calls to a server, such as payment provider server 422 of FIG. 4. For example, transfers between the users at a gas station may be batched together before being sent to the payment provider server 422. This decreases the network 114 usage and a number of calls made over network 114 by collating transactions from the customers at the gas station. In an example, the gas station may make only one consolidated transaction submission to the payment provider server 422 instead of multiple calls.

The edge server 112 may dynamically change the frequency for reconciling the batch transactions with the payment provider server 422 based on the time of the day. For example, the time interval between reconciliation of the transactions may be shorter (e.g., every 15 minutes) when the gas station is busy (e.g., during rush hour) and may be longer (e.g., every hour) when the gas station is not busy (e.g., during the night).

The edge server 112 may communicate with POS devices at multiple vendor locations and the payments at the different locations may be aggregated between different merchants and be batched together or reconciled against before being transmitted to the payment provider server 422. For example, a POS device may be located in a city such as San Jose and another POS device may be located in San Francisco. Both POS devices may connect to edge server 112. The transactions received by both POS devices from client devices 102A-D may be batched or reconciled against each other at the San Jose edge server 112. The batched transactions may than be transmitted to payment provider server 422.

In another example, the edge server 112 may communicate with each other and bath transactions at a single edge server. Suppose client devices 102A-B are connected to edge server 112 in San Francisco and client devices 102C-D are connected to a second edge server in San Jose (not shown in FIG. 4). The two edge servers may communicate with each other to batch the transactions from client devices 102A-D at edge server 112. The batched transactions may than be transmitted to payment provider server 422.

Edge server 112 may use the expert system module 110 to batch transactions from client devices 102. The expert system module 110 may dynamically batch the transactions based on the number of transactions per unit time, the number of client devices 102 performing the transactions, the aggregate amount of the transactions, and the amount in each transaction. The expert system module 110 may also periodically check the connectivity of the client devices 102A, 102B, the POS device or a combination thereof to edge server 112 to reduce the risk of the payment provider server 422 failing to process the transaction. For example, the expert system module 110 may process the transactions associated with client device 102A synchronously when client device 102A leaves the gas station and disconnects from network 108 while processing the rest of the transactions asynchronously in the batch. Alternatively, expert system module 110 may transmit all transactions in the batch to payment provider server 422 when one client device, e.g., client device 102A disconnects from network 108. In another example, expert system module 110 may also use the risk associated with client device 102A to determine when to process the transactions associated with client device 102A or a batch that includes the transactions associated with client device 102a. The risk may be determined based on the payment device history of client device 102A or information associated with client device 102A stored at merchant server 416. Expert system module 110 may process the transactions synchronously when the client device risk is high or exceeds the pre-determined individual risk threshold and process the transactions asynchronously when the risk is low is below the pre-determined risk threshold.

As discussed above, system 400 may include a payment provider server 422 connected to edge server 112 over payment network 114. Payment provider server 422 may be maintained, for example, by an online payment service provider which may provide payment between user 402 and the operator of merchant server 416. In this regard, payment provider server 422 may include one or more payment applications 424 which may be configured to interact with client device 102 and/or merchant server 416 over network 108 to facilitate the purchase of goods or services, communicate/display information, and send payments by user 402 of client device 102.

Payment provider server 422 maintains a plurality of user accounts 426, each of which may include account information 428 associated with consumers, merchants, and funding sources, such as credit card companies. For example, account information 428 may include private financial information of users of devices such as account numbers, passwords, device identifiers, usernames, phone numbers, credit card information, bank information, or other financial information which may be used to facilitate online transactions by user 402. Advantageously, payment application 424 may be configured to interact with merchant server 416 on behalf of user 402 during a transaction with checkout application 421 to track and manage purchases made by users and which and when funding sources are used.

A transaction processing application 430, which may be part of payment application 424, may be configured to receive information from a client device 102 and/or merchant server 416 for processing and storage in a payment database 432. Transaction processing application 430 may include one or more applications to process information from user 402 for processing an order and payment using various selected funding instruments, as described herein. As such, transaction processing application 430 may store details of an order from individual users, including funding source used, credit options available, and the like. Payment application 424 may be further configured to determine the existence of and to manage accounts for user 402, as well as create new accounts if necessary.

The expert system module 110 discussed above, may electronically access one or more electronic databases (e.g., the payment database 432 of the payment provider server 422 or the database 418 of the merchant server 416, or both) to access or retrieve a plurality of account parameters about user 402. The plurality of account parameters may contain event data, which may pertain to various historical events involving the user 402. For example, the event data for each event may indicate event features, such as the price and/or amount of a transaction conducted by the user 402, whether the transaction is a peer-to-peer transaction, the payment flow of the transaction, whether the transaction was authorized, and the like.

The payment network 114 in FIG. 4 may be operated by payment card service providers or card associations, such as DISCOVER™, VISA™, MASTERCARD™, AMERICAN EXPRESS™, RUPAY™, CHINA UNION PAY™, and the like.

Acquirer host 434 may be a server operated by an acquiring bank. An acquiring bank is a financial institution that accepts payments on behalf of merchants. For example, a merchant may establish an account at an acquiring bank to receive payments made via various payment cards. When a user presents a payment card as payment to the merchant, the merchant may submit the transaction to the acquiring bank. The acquiring bank may verify the payment card number, the transaction type and the amount with the issuing bank and reserve that amount of the user's credit limit for the merchant. An authorization will generate an approval code, which the merchant stores with the transaction. The transaction may be processed between payment provider server 422 and acquirer host using a payment system such as ACH, Swift, Visa, MasterCard payment network and the like.

Issuer host 436 may be a server operated by an issuing bank or issuing organization of payment cards. The issuing banks may enter into agreements with various merchants to accept payments made using the payment cards. The issuing bank may issue a payment card to a user after a card account has been established by the user at the issuing bank. The user then may use the payment card to make payments at or with various merchants who agreed to accept the payment card.

In some embodiments, assume the edge server 112 provides an interface to client devices 102A and 102B at a coffee shop. Client device 102A and the client device 102B may be associated with users in the coffee shop who may spend time at the coffee shop and make multiple transactions over during that time. The transactions may be an order for coffee from the client device 102A and an order for an ice-tea at a later time. Client device 102B may also order coffee. The edge server 112 may dynamically batch the messages associated with the transaction before sending the messages to the payment provider server 422. The edge server 112 may use expert system module 110 to make decisions regarding whether to batch messages from only client device 102A, batch messages from client devices 102A and 102B, or reconcile the messages between client device 102A and 102B at the edge server 112. The expert system module 110 may make these choices based on dynamic risk analysis discussed with respect to FIG. 1 above, and also below.

In some embodiments, the edge server 112 may dynamically batch the transaction messages received from the client device 102A and the client device 102B. The edge server 112 may query the merchant server 416 using a Graph QL query to receive client device parameters associated with the client devices 102A and 102B. The trust calculator 316 may determine a risk associated with the client device 102A and the client device 102B. For example, assume client device 102A is associated with user 402 who regularly engages in transactions at the coffee shoe and client device 102B associated with another user who occasionally visits the coffee shop. The trust calculator 316 may use the transaction history at merchant server 416 to determine that the transaction risk associated with the client device 102A is low and the transaction risk associated with the client device 102 is high.

The edge server 112 may determine an aggregate dynamic transaction risk for batching the transaction messages based on the transaction risk associated with the client device 102A and client device 102B. In an example, the expert system module 110 may determine the aggregate dynamic transaction risk based on time between settling the transactions, the value of the transactions in the batch, the value of an individual transaction in the batch, the connectivity state between the client devices 102A and/or 102B and the edge server 112, and the like. Expert system module 110 may also modify or update the aggregate dynamic transaction risk based on these parameters. The edge server 112 may retrieve a pre-determined aggregate transaction risk threshold from the payment provider server 422. The edge server 112 may accumulate transactions from the client device 102A, the client device 102B or both in a batch when the aggregate dynamic transaction risk is less than a pre-determined aggregate risk threshold. When the edge server 112 determines that the aggregate dynamic transaction risk exceeds the pre-determined aggregate risk threshold, edge server 112 may transmit the batch of transaction messages to payment provider server 422 in payment network 114.

As discussed above, the edge server 112 may receive two transaction messages (transactions for coffee and ice-tea) from the client device 102A. The edge server 112 may determine a device dynamic transaction risk for client device 102A that identifies a number of transaction messages from client device 102A that may be included in the batch. The device dynamic transaction risk may be based on a maximum value of the batched transactions, a maximum value of an individual transaction, an amount of time remaining before a transaction or the batched transactions from client device 102A should be synchronized with payment provider server 422, and the like. The device dynamic transaction risk may also vary based on the previous transaction history of the client device 102A, such as a history of declined or cleared payments and the like. The edge server 112 may determine that the device dynamic transaction risk exceeds a pre-determined individual risk threshold for the client device 102A. The edge server 112 may in response to determining that the device dynamic transaction risk exceeds the pre-determined individual risk threshold for client device 102A, transmit the transaction message to network 114.

For example, suppose edge server 112 determines that device dynamic transaction risk is two transaction messages and the pre-determined individual risk threshold is five transaction messages. The edge server 112 may continue to batch transactions from client device 102A. In another example, suppose edge server 112 determines that device dynamic transaction risk is two transaction messages and the pre-determined individual risk threshold is two transaction messages. The edge server 112 may transmit the batch with two transaction messages over network 114.

In another example, suppose edge server 112 determines that device dynamic transaction risk is five dollars (two for the coffee transaction and three for the ice-tea transaction) and the pre-determined individual risk threshold is ten dollars. The edge server 112 may continue to batch transactions from client device 102A. Suppose the pre-determined individual risk threshold is four dollars. In this case, the edge server 112 may transmit the batch with two transaction messages over network 114. Suppose the pre-determined individual risk threshold is four dollars. In this case, the edge server 112 may transmit the coffee transaction message over network 114 and the ice-tea transaction message over network 114 without batching the two transactions.

Suppose for purposes of the examples below, client device 102A has a low denials associated with the prior transaction history. Based on the low denials, edge server 112 may classify client device 102A as low risk and assign the device dynamic transaction risk threshold for client device 102A. The edge server 112 may receive a first transaction message from client device 102A and a second transaction message from client device 102B. The first and second transaction messages may be part of the transaction messages from multiple other client devices 102 that are dynamically batched at edge server 112. The edge server 112 may batch the transactions from client devices 102, including client device 102A for asynchronous processing as long as the device dynamic transaction risk is below a pre-determined individual transaction risk threshold. The device dynamic transaction risk threshold for client device 102A may changes when additional transaction messages from client device 102A are added to the batch. When the edge server 112 determines that the device dynamic transaction risk for the client device 102A exceeds the pre-determined individual transaction risk threshold for the client device 102A, the edge server 112 may transmit the batched transaction messages including the first transaction message and the second transaction message to network 114 for settlement.

In another example, suppose merchant server 416 identified client device 102A as having frequent transaction denials. Based on the high denials, edge server 112 may classify client device 102A as high risk and assign a low device dynamic transaction risk threshold for client device 102A. Suppose also that merchant server 416 identified client device 102B as low risk and assigned a high device dynamic transaction risk threshold for client device 102B. The edge server 112 may receive transactions from client device 102B that are batched together, and a transaction message from client device 102A that is added to the batch. Because the device dynamic transaction risk for the client device 102A exceeds the pre-determined individual transaction risk threshold, the edge server 112 may transmit the batched transaction messages from client devices 102A and 102B to network 114. The transmission may occur even though the device dynamic transaction risk threshold associated with multiple transaction messages from client device 102B did not exceed the pre-determined individual transaction risk threshold.

The transaction messages from client device 102A may be part of the transaction messages from multiple other client devices 102 that are dynamically batched at edge server 112. The edge server 112 may batch the transaction messages from client devices 102, including client device 102A, for asynchronous processing as long as the device dynamic transaction risk for client device 102A is below a pre-determined individual transaction risk threshold. The device dynamic transaction risk threshold for client device 102A may change when additional transaction messages from client device 102A are added to the batch. When the edge server 112 determines that the device dynamic transaction risk for the client device 102A exceeds the pre-determined individual transaction risk threshold, the edge server 112 may transmit the batched transaction messages including the transaction messages associated with client device 102A to network 114 for settlement.

In some embodiments, edge server 112 may use the aggregate dynamic transaction risk to dynamically batch transaction messages. The edge server 112 may set a pre-determined aggregate risk threshold based on merchant server 416 or retrieve the aggregate dynamic transaction risk from payment provider server 422. As the transaction messages are dynamically batched at the edge server 112, edge server 112 may determine the aggregate dynamic transaction risk. The edge server 112 may transmit the batched transaction messages when the aggregate dynamic transaction risk exceeds a pre-determined aggregate risk threshold, to mitigate risk

In some embodiments, edge server 112 may dynamically batch transaction messages using the aggregate dynamic transaction risk and device dynamic transaction risk. For example, edge server 112 may receive and batch a first transaction message and a second transaction message from the client device 102A with other transaction messages. The edge server 112 may determine a device dynamic transaction risk for client device 102A. The edge server 112 may determine that the device dynamic transaction risk for the client device 102A exceeds a pre-determined individual risk threshold for the client device 102A and the aggregate dynamic transaction risk does not exceed the pre-determined aggregate risk threshold. In response to the determination, the edge server 112 may still transmit the batched transaction messages even though the aggregate dynamic transaction risk does not exceed a pre-determined aggregate risk threshold.

In some embodiments, assume, client device 102A and the client device 102B are exchanging funds between each other. The edge server 112 may receive a first transaction message from client device 102A and a second transaction message from client device 102B. The edge server 112 may determine that the first transaction message is a debit request to the client device 102A and the second transaction message is a corresponding credit request to the client device 102B. The edge server 112 may settle the first transaction message and the second transaction message at the edge server 112 without transmitting the first and second transaction message to the network 114. In such a transaction, the edge server 112 may determine the difference between the debit message and the credit message and transmit the difference (if any) to the payment network 114 and the payment provider server 422. The edge server 112 can settle the transaction with fewer requests to the payment network 114.

In some embodiments, edge server 112 may determine a tokenized payment credential associated with client device 102A based on at least one of a trust score associated with the client device 102A in network 108, the pre-determined aggregate risk threshold, a pre-determined settlement time limit associated with client device 102A, or a connectivity status indication associated with client device 102A. The edge server 112 may vary the pre-determined aggregated risk threshold based on the tokenized payment credential.

The edge server 112 may generate a tokenized payment credential for the client device 102A during a transaction between client device 102A and a POS device. The tokenized payment credential may then be transmitted to the client device 102A. The tokenized payment credential may include information such as the value of the transactions that is currently authorized for the client device 102A, the means of identification of the financial instrument to use, the time limit before the batched transactions are to be settled and the like. The tokenized payment credential may then be returned to the edge server 112 with additional changes to the state value to settle transactions through the payment provider server 422. The tokenized payment credential may or may not require pre-approval of the payment provider server 422. In an example, the edge server 112 may obtain pre-authorization from the payment provider server 422 before issuing a tokenized payment credential to client devices 102.

In some embodiment, the edge server 112 may receive transaction messages from client device 102A accessing network 108 via a POS device in a coffee shop. A tokenized payment credential associated with the client device 102A may be transmitted as part of the transaction message(s). From the tokenized payment credential, edge server 112 may determine the dynamic transaction risk associated with the client device 102A. For example, the edge server 112 may use the tokenized payment credential to learn the prior transaction history of the client device 102A, which indicates that client device 102A spends a certain dollar value at the coffee shop each day and the transaction is processed successfully. The edge server may determine the device dynamic transaction risk threshold based on this information.

The edge server 112 may determine whether an aggregate dynamic transaction risk associated with the batched transaction messages exceeds a transaction limit in the tokenized payment credential. The edge server 112 may transmit the transaction messages to network 114 once the batched transaction messages exceed the transaction limit. Edge server 112 may determine the tokenized payment credential associated with the client device 102A based on at least one of a trust score associated with the client device 102A in network 108, a pre-determined aggregate risk threshold, a pre-determined settlement time limit associated with the client device 102A, or a connectivity status indication associated with the client device 102A.

In some embodiments, the edge server 112 may determine statuses of the transaction messages from the one or more client devices 102 connected to network 108. The statuses may indicate whether the transaction messages were successfully or unsuccessfully processed at network 114. The edge server 112 may adjust the pre-determined aggregate risk threshold based on the statuses of the transaction messages. For example, the edge server 112 may dynamically increase the transaction limit of the transaction messages aggregated in a batch based on the prior transactions being successfully processed.

In some embodiment, the edge server 112 may determine the transaction limit based on at least one of a trust score associated with the one or more client devices 102 in network 108, a pre-determined settlement time limit associated with the one or more client devices 102, or a connectivity status indication associated with the one or more client devices 102. The edge server 112 may receive receiving another transaction message from the client device 102A. The edge server 112 may determine that the transaction message from client device 102A exceeds a device dynamic transaction risk for the client device 102A but not the transaction limit. The edge server 112 may batch the transaction message from client device 102A with the other transaction messages and transmit the batch to network 114.

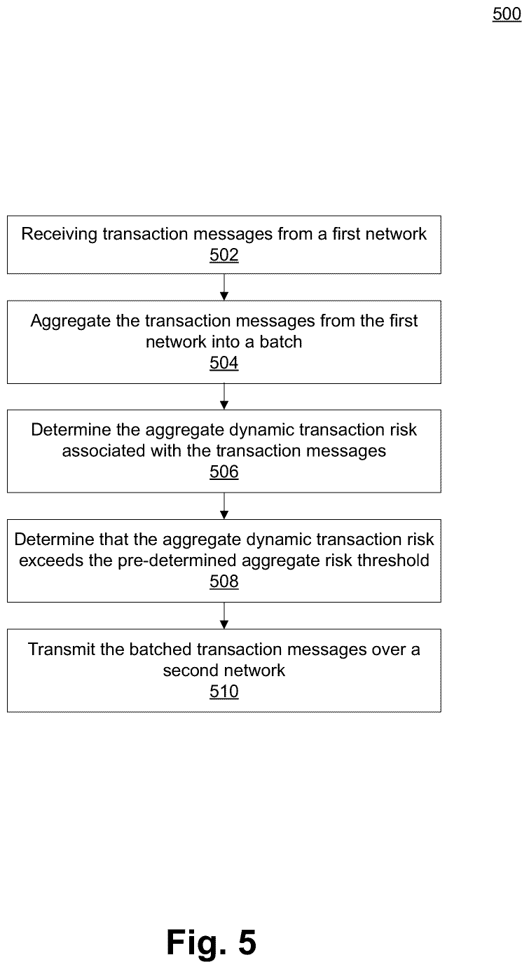

FIG. 5 is a flowchart illustrating a method 500 for dynamically batching transaction messages, according to the embodiments. The various steps of the method 500, which are described in greater detail above, may be performed by one or more electronic processors. In some embodiments, at least some of the steps of the method 500 may be performed by the expert system module 110 discussed above.

At operation 502, transaction messages are received. For example, transaction messages are received from at edge server 112 from client devices 102A-B connected to edge server 112 over network 108.

At operation 504, transaction messages are aggregated. For example, edge server 112 may aggregate the transaction messages from the client devices 102A-B into a batch.

At operation 506, an aggregate dynamic transaction risk is determined. For example, edge server 112 may determine the aggregate dynamic transaction risk for the transaction messages from the client device 102A-B.

At operation 508, a determination that the aggregate dynamic transaction risk exceeds a pre-determined aggregate risk threshold is made. For example, edge server 112 may determine that the aggregate dynamic transaction risk exceeds the pre-determined aggregate risk threshold.

At operation 510, a batch is transmitted over a second network. For example, in response to edge server 112 determining that the aggregate dynamic transaction risk exceeds the pre-determined aggregate risk threshold, edge server 112 may transmit the transaction messages over network 114 for processing. For example, edge server 112 may transmit the transaction messages over network 114 for settlement.

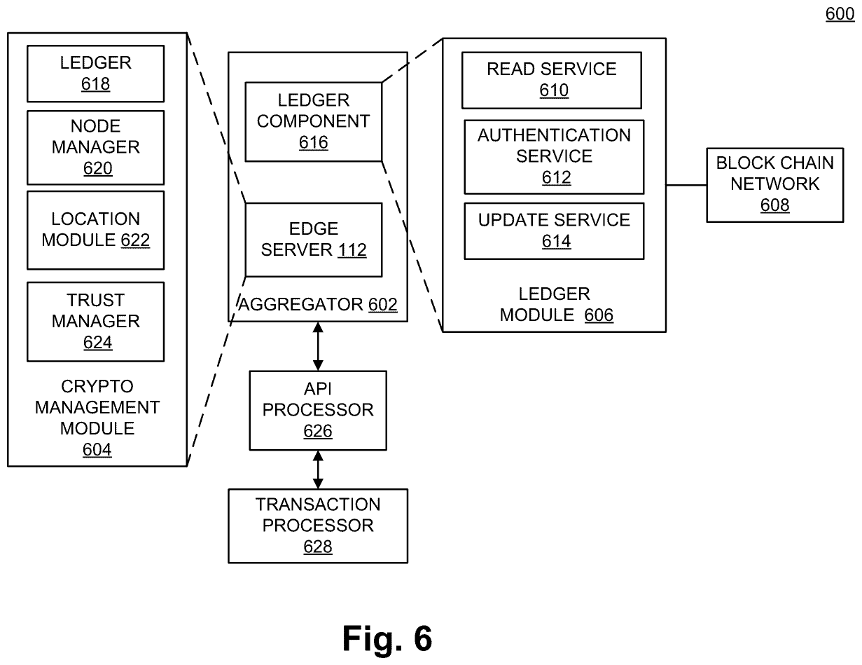

FIG. 6 is a block diagram of a system 600 suitable for conducting electronic online transactions on a blockchain, according to aspects of the disclosure. The system 600 may include an aggregator 602, a ledger module 606 in communication with a blockchain network 608. Aggregator 602 may include an edge server 112 and a ledger component 616. The edge server 112 may include a crypto management module 604. The crypto management module 604 may include a ledger 618, a node manager 620, a location module 622 and a trust manager 624. The aggregator 602 may interface with an API processor 626 and the transaction processor 628 to perform transactions such as the through the payment networks described above with reference to FIG. 4.

The blockchain network 608 may be a shared, immutable ledger that facilitates the process of recording transactions and tracking assets in a network. An asset can be tangible (a house, car, cash, land) or intangible (intellectual property, patents, copyrights, branding). Virtually anything of value can be tracked and traded on a blockchain network 608, reducing risk and cutting costs for all involved.

Blockchain network 608 may include transactions that show the movement of an asset. In the blockchain network 608 a data block may record the information such as who, what, when, where, how much and even the condition—such as the temperature of a food shipment. In the blockchain network 608 one or more blocks form a chain of data as an asset moves from place to place or ownership changes hands. The blocks in the blockchain network 608 confirm the exact time and sequence of transactions, and the blocks link securely together to prevent any block from being altered or a block being inserted between two existing blocks.

Each additional block in the blockchain network 608 strengthens the verification of the previous block and hence the entire blockchain network 608. This renders the blockchain network 608 tamper-evident, delivering the key strength of immutability. This removes the possibility of tampering by a malicious actor—and builds a ledger of transactions you and other network members can trust. The blockchain network 608 may be a public blockchain network, a private blockchain network, a permissioned blockchain network, consortium blockchain network or the like.

In an example, the edge server 112 may include the ledger component 616 that houses the ledger module 606 that provides services such as read service 610, authentication service 612 and update service 614 to interact with the blockchain network 608. For example, the read service 610 may read the transactions recorded on the blockchain network 608. The read service 614 may search for a node path for the blockchain network 608 and get the node path based on a hash. Authentication service 612 may authenticate the transaction records on the blockchain network 608. Authentication service 612 may register the user or authenticate the user to the blockchain network 608 to write transactions to the blockchain network 608. The update service 614 may update transactions that are on the edge server 112 to the blockchain network 608. The update service 614 may create a node in the node path of the blockchain network 608 in a new block. The update service 614 may update a node in the node path when reconciling transactions with the blockchain network 608.

The edge server 112 may aggregate the plurality of transaction messages received from network 108 shown in FIG. 4 with transaction messages on the blockchain network 608. In an example, the transaction messages may be received from the client device 102A, from the client device 102B, from both the client devices 102A and 102B, or the like. The edge server 112 may determine via the trust manager 624 an aggregate dynamic transaction risk for the transaction messages. The edge server 112 may also determine that the aggregate dynamic transaction risk of the blockchain transactions exceeds a pre-determined aggregate risk threshold. The edge server 112 may in response to determining that the aggregate dynamic transaction risk exceeds a pre-determined aggregate risk threshold, transmit the aggregated transaction messages to another network, such as the blockchain network 608.

In some embodiments, the edge server 112 may receive a transaction message from client device 102A for a blockchain network 608 transaction. The edge server 112 may determine a device dynamic transaction risk for client device 102A. The edge server 112 may determine that the device dynamic transaction risk exceeds a pre-determined individual risk threshold for the client device 102A. In response to determining that the device dynamic transaction risk exceeds the pre-determined individual risk threshold, edge server 112 may transmit the transaction message to the blockchain network 608.

In another example, the edge server 112 may store other transaction messages on the ledger 618 until the dynamic transaction risk associated with client device 102A is exceeded. For example, once edge server 112 receives the transaction message from client device 102A, the edge server 112 may determine the device dynamic transaction risk exceeds a pre-determined individual risk threshold for client device 102A. In response to determining that the device dynamic transaction risk exceeds the pre-determined individual risk threshold, edge server 112 may transmit the first transaction message batched with other transaction messages from the ledger 618 to the blockchain network 608.

The trust manager 624 may determine when to synchronize the transaction messages based on inputs from the location module 622. Location module 622 may determine locations of the client devices 102A-B. For example, location module 622 may determine that client device 102A is no longer in communication with the edge server 112 and synchronize the transaction messages from client device 102A or transaction messages from client device 102A batched with other transaction messages to the blockchain network 608.

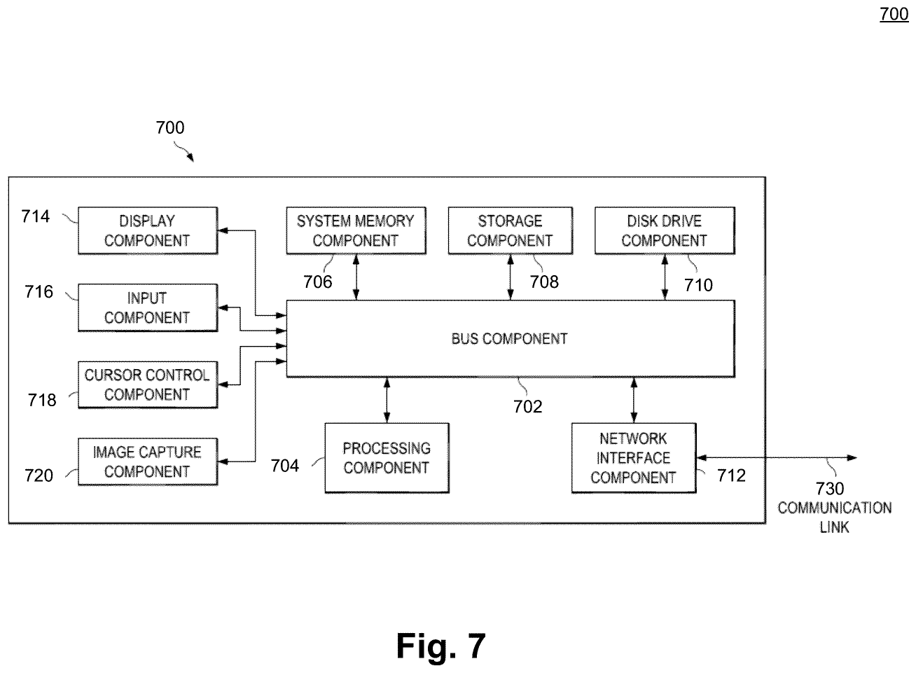

FIG. 7 is a block diagram of a computer system 700 suitable for implementing various methods and devices described herein, including the components discussed in FIGS. 1 and 4.

In accordance with various embodiments of the disclosure, the computer system 700, such as a network server or a mobile communications device, includes a bus component 702 or other communication mechanisms for communicating information, which interconnects subsystems and components, such as a computer processing component 704 (e.g., processor, micro-controller, digital signal processor (DSP), etc.), system memory component 706 (e.g., RAM), static storage component 708 (e.g., ROM), disk drive component 710 (e.g., magnetic or optical), network interface component 712 (e.g., modem or Ethernet card), display component 714 (e.g., cathode ray tube (CRT) or liquid crystal display (LCD)), input component 716 (e.g., keyboard), cursor control component 718 (e.g., mouse or trackball), and image capture component 720 (e.g., analog or digital camera). In one implementation, disk drive component 710 may comprise a database having one or more disk drive components.

In accordance with embodiments of the disclosure, computer system 700 performs specific operations by the processor 704 executing one or more sequences of one or more instructions contained in system memory component 706. Such instructions may be read into system memory component 706 from another computer readable medium, such as static storage component 708 or disk drive component 710. In other embodiments, hard-wired circuitry may be used in place of (or in combination with) software instructions to implement the disclosure.

Logic may be encoded in a computer readable medium, which may refer to any medium that participates in providing instructions to the processor 704 for execution. Such a medium may take many forms, including but not limited to, non-volatile media and volatile media. In one embodiment, the computer readable medium is non-transitory. In various implementations, non-volatile media includes optical or magnetic disks, such as disk drive component 710, and volatile media includes dynamic memory, such as system memory component 706. In one aspect, data and information related to execution instructions may be transmitted to computer system 700 via a transmission media, such as in the form of acoustic or light waves, including those generated during radio wave and infrared data communications. In various implementations, transmission media may include coaxial cables, copper wire, and fiber optics, including wires that comprise bus 702.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. These computer readable media may also be used to store the programming code for the expert system module 110 discussed above.

In various embodiments of the disclosure, execution of instruction sequences to practice the disclosure may be performed by computer system 700. In various other embodiments of the disclosure, a plurality of computer systems 700 coupled by communication link 730 (e.g., a communications network, such as a LAN, WLAN, PT SN, and/or various other wired or wireless networks, including telecommunications, mobile, and cellular phone networks) may perform instruction sequences to practice the disclosure in coordination with one another.

Computer system 700 may transmit and receive messages, data, information and instructions, including one or more programs (i.e., application code) through communication link 730 and communication interface 712. Received program code may be executed by computer processor 704 as received and/or stored in disk drive component 710 or some other non-volatile storage component for execution. The communication link 730 and/or the communication interface 712 may be used to conduct electronic communications with external devices, such as devices connected to the networks discussed in FIGS. 1 and 4.

Where applicable, various embodiments provided by the disclosure may be implemented using hardware, software, or combinations of hardware and software. Also, where applicable, the various hardware components and/or software components set forth herein may be combined into composite components comprising software, hardware, and/or both without departing from the spirit of the disclosure. Where applicable, the various hardware components and/or software components set forth herein may be separated into sub-components comprising software, hardware, or both without departing from the scope of the disclosure. In addition, where applicable, it is contemplated that software components may be implemented as hardware components and vice-versa.

Software, in accordance with the disclosure, such as computer program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein. It is understood that at least a portion of the expert system module 110 may be implemented as such software code.

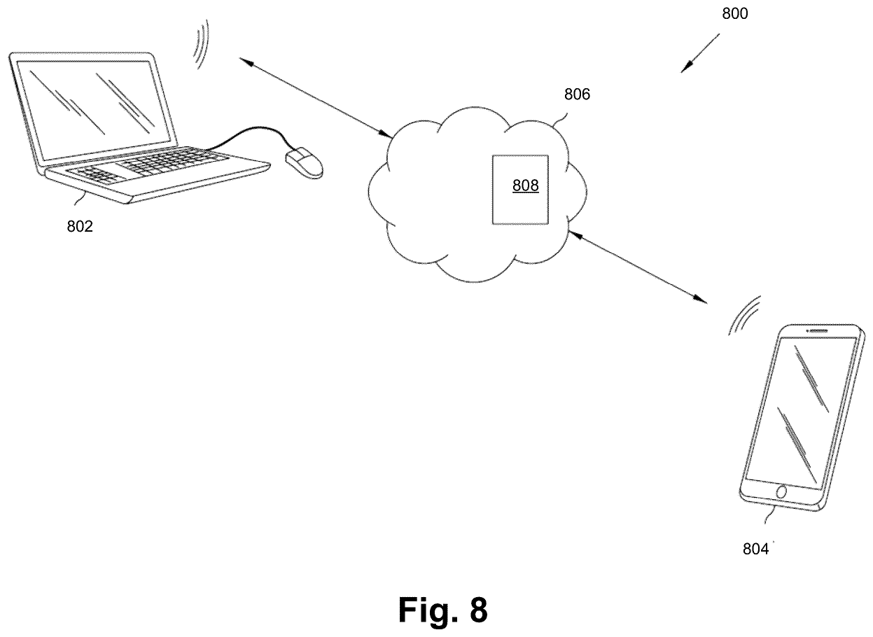

FIG. 8 illustrates an example cloud-based computing architecture 800, which may also be used to implement various aspects of the disclosure. The cloud-based computing architecture 800 includes a mobile device 804 (e.g., the client device 102 of FIGS. 1 and 4) and a computer 802 (e.g., the merchant server 416 or the payment provider server 422), both connected to a computer network 806 (e.g., the Internet or an intranet). In one example, a consumer has the mobile device 804 that is in communication with cloud-based resources 808, which may include one or more computers, such as server computers, with adequate memory resources to handle requests from a variety of users. A given embodiment may divide up the functionality between the mobile device 804 and the cloud-based resources 808 in any appropriate manner. For example, an app on mobile device 804 may perform basic input/output interactions with the user, but a majority of the processing may be performed by the cloud-based resources 808. However, other divisions of responsibility are also possible in various embodiments. In some embodiments, using this cloud architecture, the expert system module 110 may reside on the merchant server 416 or the payment provider server 810, but its functionalities can be accessed or utilized by the mobile device 804, or vice versa.

The cloud-based computing architecture 800 also includes the personal computer 802 in communication with the cloud-based resources 808. In one example, a participating merchant or consumer/user may access information from the cloud-based resources 808 by logging on to a merchant account or a user account at computer 802. The system and method for performing the expert system analysis as discussed above may be implemented at least in part based on the cloud-based computing architecture 800.

It is understood that the various components of cloud-based computing architecture 800 are shown as examples only. For instance, a given user may access the cloud-based resources 808 by a number of devices, not all of the devices being mobile devices. Similarly, a merchant or another user may access the cloud-based resources 808 from any number of suitable mobile or non-mobile devices. Furthermore, the cloud-based resources 808 may accommodate many merchants and users in various embodiments.

Based on the above discussions, systems and methods described in the disclosure offer several significant advantages over other methods and systems. It is understood, however, that not all advantages are necessarily discussed in detail herein, different embodiments may offer different advantages, and that no particular advantage is required for all embodiments. One advantage is improved functionality of a computer. For example, some computer systems that are used in reconciling messages or transactions include an apex server that reconciles all transaction messages. Embodiments described herein, however, include an edge server that dynamically decides which messages can be processed locally, which messages should be batch processed or asynchronously processed at a later time with a device on the second network and which messages should be synchronously processed with the device on the second network, which improves the quality of service (QoS) of the messaging network as a whole. The edge server may include the expert system module 110 to dynamically batch process message or transactions.

The inventive ideas of the disclosure are also integrated into a practical application, for example into the expert system module 110 discussed above. Such a practical application can reduce network utilization, reduce latency and optimize quality of service of the network.

It should be appreciated that like reference numerals are used to identify like elements illustrated in one or more of the figures, wherein these labeled figures are for purposes of illustrating embodiments of the disclosure and not for purposes of limiting the same.

The foregoing disclosure is not intended to limit the disclosure to the precise forms or particular fields of use disclosed. As such, it is contemplated that various alternate embodiments and/or modifications to the disclosure, whether explicitly described or implied herein, are possible in light of the disclosure. Having thus described embodiments of the disclosure, persons of ordinary skill in the art will recognize that changes may be made in form and detail without departing from the scope of the disclosure. Thus, the disclosure is limited only by the claims.

What is claimed is:

1. A system, comprising:
a non-transitory memory; and
one or more hardware processors coupled to the non-transitory memory and configured to read instructions from the non-transitory memory to cause the system to perform operations comprising:
receiving, at an edge server, a plurality of transaction messages from a first network, wherein the first network communicatively connects one or more client devices and the edge server;
aggregating, via the edge server, the plurality of transaction messages received from the first network;
determining, via the edge server, an aggregate dynamic transaction risk for the plurality of transaction messages;
determining that the aggregate dynamic transaction risk exceeds a pre-determined aggregate risk threshold; and
in response to determining that the aggregate dynamic transaction risk exceeds a pre-determined aggregate risk threshold, transmitting the aggregated plurality of transaction messages to a second network, wherein the second network communicatively connects one or more transaction processors.

2. The system of claim 1, wherein the operations further comprise:
receiving a first transaction message from a first client device in the one or more client devices;
determining, via the edge server, a device dynamic transaction risk for the first client device;
determining, via the edge server, that the device dynamic transaction risk exceeds a pre-determined individual risk threshold for the first client device; and
in response to determining that the device dynamic transaction risk exceeds the pre-determined individual risk threshold, transmitting the first transaction request to the second network.

3. The system of claim 1, wherein the operations further comprise:
receiving a first transaction request from a first client device and a second transaction request from a second client device, wherein the first and second transaction requests are in the plurality of transaction requests, and wherein the first and second client devices are in the one or more client devices;
determining, via the edge server, a device dynamic transaction risk for the first client device;
determining, via the edge server, that the device dynamic transaction risk for the first client device exceeds a pre-determined individual transaction risk threshold for the first client device; and
in response to determining that the device dynamic transaction risk exceeds a pre-determined individual risk threshold, transmitting the plurality of transaction requests including both the first transaction request and the second transaction request to the second network for settlement.

4. The system of claim 1, wherein the operations further comprise:
receiving a first transaction request and a second transaction request from a first client device in the one or more client devices;
aggregating, via the edge server, the first transaction request and the second transaction request with the plurality of the transaction requests;
determining, via the edge server, a device dynamic transaction risk for the first client device;
determining, via the edge server, that the device dynamic transaction risk for the first client device exceeds a pre-determined individual risk threshold for the first client device and the aggregate dynamic transaction risk does not exceed the pre-determined aggregate risk threshold; and
in response to determining that the device dynamic transaction risk exceeds the pre-determined individual risk threshold and the aggregate dynamic transaction risk does not exceed a pre-determined aggregate risk threshold, transmitting the aggregated plurality of transaction requests to the second network.

5. The system of claim 1, wherein the operations further comprise:
receiving a first transaction request from a first client device and a second transaction request from a second client device, and wherein the first and second client devices are in the one or more client devices;
determining that the first transaction request is a debit request to the first client device and the second transaction request is a corresponding credit request to the second client device; and
settling the first transaction request and the second transaction request at the edge server without transmitting the first and second transaction requests to the second network.

6. The system of claim 1, wherein the operations further comprise:
determining a tokenized payment credential associated with a first client device based on at least one of a trust score associated with the first client device in the first network, the pre-determined aggregate risk threshold, a pre-determined settlement time limit associated with the first client device, or a connectivity status indication associated with the first client device; and
varying the pre-determined aggregated risk threshold based on the tokenized payment credential.

7. The system of claim 1, wherein the operations further comprise:
determining a status of the plurality of transactions requests from the one or more client devices at the first network, whereby the status indicates whether the plurality of transaction requests were successfully or unsuccessfully processed at the second network; and
adjusting the pre-determined aggregate risk threshold based on the status of the plurality of transaction requests.

8. The system of claim 1, wherein the one or more transaction processors is a blockchain payment processor.

9. A method comprising:
receiving, at an edge server and over a pre-determined time interval, an asynchronous transmission comprising a plurality of transaction requests from a first network, wherein the first network communicatively connects one or more client devices and the edge server;
querying, via the edge server, an account parameter associated with the one or more client devices from a second network, wherein the second network communicatively connects one or more transaction processors and the edge server;
determining, via the edge server, an aggregate dynamic transaction risk associated with the one or more client devices based on the account parameter;
determining that the aggregate dynamic transaction risk exceeds a pre-determined aggregate risk threshold; and
in response to determining that the aggregate dynamic transaction risk exceeds the pre-determined aggregate risk threshold, transmitting the plurality of transaction requests to the second network.

10. The method of claim 9, further comprising:
determining, via the edge server, a device dynamic transaction risk for a first client device in the one or more client devices, the first client device associated with at least one transaction request in the plurality of transaction requests;
determining, via the edge server, whether the device dynamic transaction risk for the first client device exceeds a pre-determined individual transaction risk threshold for the first client device; and
in response to the determination that the device dynamic transaction risk exceeds a pre-determined individual risk threshold but not the pre-determined aggregate risk threshold, transmitting the plurality of transaction requests to the second network.

11. The method of claim 9, further comprising:
determining a tokenized payment credential associated with a first client device based on at least one of a trust score associated with the first client device in the first network, the pre-determined aggregate risk threshold, a pre-determined settlement time limit associated with the first client device, or a connectivity status indication associated with the first client device; and
varying the pre-determined aggregated risk threshold based on the tokenized payment credential.

12. The method of claim 9, further comprising:
determining a tokenized payment credential associated with a first client device based on at least one of a trust score associated with the first client device in the first network, the pre-determined aggregate risk threshold, a pre-determined settlement time limit associated with the first client device, or a connectivity status indication associated with the first client device; and
determining, that a device dynamic transaction risk associated with the first client device exceeds the pre-determined aggregate risk threshold based on the tokenized payment credential; and
transmitting at least one transaction request in the plurality of transaction requests to the second network, wherein the at least one transaction request is associated with the first client device.

13. The method of claim 9, wherein the plurality of transaction requests include a first transaction request from a first client device, wherein the first client device is in the one or more client devices, and further comprising:
determining, via the edge server, a device dynamic transaction risk for the first client device;
determining, via the edge server, that the device dynamic transaction risk exceeds a pre-determined individual transaction risk threshold for the first client device; and
in response to the determination that the device dynamic transaction risk exceeds the pre-determined individual transaction risk threshold, transmitting the plurality of transaction requests to the second network.

14. The method of claim 9, wherein the plurality of transaction requests include a first transaction request from a first client device and a second transaction request from a second client device, wherein the first and second client devices are in the one or more client devices;
determining that the first transaction request is a debit request to the first client device and the second transaction request is a corresponding credit request to the second client device; and
settling, via the edge server, the first transaction request and the second transaction request without sending the first and second transaction requests with other transaction requests in the plurality of transaction requests to the second network.

15. The method of claim 9, wherein the one or more transaction processors is a blockchain payment processor.

16. The method of claim 9, further comprising:
storing the plurality of the transaction requests received in the asynchronous transmission at the edge server prior to transmitting the plurality of transaction requests as a single request to the second network.

17. A non-transitory machine-readable medium having stored thereon machine-readable instructions, that when executed, cause a machine to perform operations comprising:
receiving, at an edge server, a plurality of transaction requests from a client device in a first network, wherein the first network communicatively connects the edge server to one or more client devices including the client device;
determining, via the edge server, a tokenized payment credential associated with the client device in the first network based on a dynamic transaction risk;
aggregating, via the edge server, the plurality of transaction requests from the client device without processing the transaction requests to reduce network utilization between the edge server and a second network, wherein the second network communicatively connects one or more transaction processors and the edge server;
determining whether an aggregate dynamic transaction risk associated with the plurality of aggregated transaction requests exceeds a transaction limit in the tokenized payment credential; and
in response to determining that the aggregate dynamic transaction risk exceeds the transaction limit, transmitting the plurality of transaction requests to the second network.

18. The non-transitory machine-readable medium of claim 17, wherein the machine-readable instructions, that when executed, further cause the machine to perform operations comprising:
determining the tokenized payment credential associated with the client device based on at least one of a trust score associated with the client device in the first network, a pre-determined aggregate risk threshold, a pre-determined settlement time limit associated with the client device, or a connectivity status indication associated with the client device.

19. The non-transitory machine-readable medium of claim 17, wherein the machine-readable instructions, that when executed, further cause the machine to perform operations comprising:
determining the transaction limit based on at least one of a trust score associated with the one or more client devices in the first network, a pre-determined settlement time limit associated with the one or more client devices, or a connectivity status indication associated with the one or more client devices.

20. The non-transitory machine-readable medium of claim 17, wherein the machine-readable instructions further cause the machine to perform operations comprising:
receiving another transaction request from the client device;
determining that the other transaction request exceeds a device dynamic transaction risk for the client device but not the transaction limit; and
in response to determining that the other transaction request exceeds the device dynamic transaction risk, transmitting the other transaction request and the plurality of transaction requests to the second network.
